(19) United States
(12) Patent Application Publication
(10) Pub. No.: US 2010/0032292 A1
(43) Pub. Date: Feb. 11, 2010

(54) AMMONIA GAS SENSOR

(76) Inventors: Da Yu Wang, Troy, MI (US); David Racine, Grand Blanc, MI (US); David D. Cabush, Howell, MI (US)

Correspondence Address: Delphi Technologies, Inc., M/C 480-410-202, PO BOX 5052, Troy, MI, 48007, US

(21) Appl. No.: 12/187,849

(22) Filed: Aug. 7, 2008

(51) Int. Cl. G01N 27/30

(52) U.S. Cl. 204/431

(57) ABSTRACT

A single-cell sensor element is configured for ammonia gas sensing. The sensor includes an electrolyte layer, an NH₃ sensing electrode and a NOₓ sensing electrode. The NH₃ sensing electrode is sensitive to NH₃ but is also vulnerable to cross-interference from NO₂. To directly correct for this cross-interference, a second (NOₓ) electrode is provided and is used in a differential connection arrangement with the NH₃ sensing electrode. The NOₓ sensing electrode has a first electrochemical sensitivity to NO₂ that is greater than second and third electrochemical sensitivities to NH₃ and NO, respectively. The NOₓ sensing electrode may have low or no sensitivity to NH₃ or NO. The sensor element also includes first and second electrical leads respectively connected to the NH₃ and NOₓ sensing electrodes. The output signal developed across the first and second leads is directly indicative of an ammonia concentration in a gas exposed to the NH₃ and NOₓ sensing electrodes, thereby eliminating the need for emf selection rules to be programmed into an electronic controller to which the sensor is connected.

### INCORPORATION BY REFERENCE

This application incorporates by reference the disclosure of the following in their entireties: U.S. application Ser. No. 11/538,240 filed on Oct. 3, 2006 entitled “MULTICELL AMMONIA SENSOR AND METHOD OF USE THEREOF” (attorney docket no. DP-313576); U.S. application Ser. No. 11/451,939 filed on Jun. 13, 2006 entitled “SYSTEM AND METHOD FOR MONITORING OPERATION OF AN EXHAUST GAS TREATMENT SYSTEM” (attorney docket no. DP-314445); U.S. Provisional Application No. 60/725,054 filed Oct. 7, 2005; U.S. Provisional Application No. 60/725,055 filed Oct. 7, 2005; U.S. Provisional Application No. 60/734,087 filed Nov. 7, 2005; and U.S. Pat. No. 7,074,319 issued Jul. 11, 2006 entitled “AMMONIA GAS SENSORS”.

### BACKGROUND OF THE INVENTION

Exhaust gas generated by combustion of fossil fuels in furnaces, ovens, and engines contain, for example, nitrogen oxides (NOₓ), unburned hydrocarbons (HC), and carbon monoxide (CO). Vehicles, e.g., diesel vehicles, utilize various pollution-control after treatment devices (such as a NOₓ absorber(s) and/or selective catalytic reduction (SCR) catalyst(s)), to reduce NO_{X}. For diesel vehicles using SCR catalysts, NO_{X} reduction can be accomplished by using ammonia gas (NH₃) or urea water solution. In order for SCR catalysts to work efficiently and to avoid pollution breakthrough, an effective feedback control loop is needed. To develop such technology, the control system needs reliable commercial ammonia sensors.

One group of ammonia sensor designs operate based on the Nernst Principle, where the sensor converts chemical energy from NH₃ into electromotive force (emf). The sensor can measure this electromotive force to determine the partial pressure of NH₃ in a sample gas. However, these sensors also convert the chemical energy from NO_{X} gas into electromotive force. Therefore, when determining partial pressure based on electromotive force, the sensor is not able to effectively distinguish between NH₃ and NO_{X}.

Therefore, the control system would benefit from a sensor that can measure the partial pressure of NH₃ in the presence of NO_{X}.

### SUMMARY OF THE INVENTION

The invention provides a simplified single-cell sensor element configured for ammonia gas sensing. The sensor element is based on an ammonia sensing electrode and a reference (NO_{X}) electrode that will eliminate a so-called NO₂ cross interference effect on the ammonia sensing electrode. The simplified sensor element uses a reduced number of electrical leads (wires) for connection to an electronic controller or the like, saving cost relative to known approaches. In addition, the sensor element provides an output signal that is directly indicative of an ammonia gas concentration, thereby eliminating the need for so-called emf selection rules to be programmed into the controller.

A sensor according to the invention includes an electrolyte layer, an NH₃ sensing electrode and a NO_{X} sensing electrode. The NH₃ sensing electrode is disposed on and in ionic communication with the electrolyte layer. The NO_{X} sensing electrode is offset from the NH₃ sensing electrode and is also disposed on and in ionic communication with the electrolyte layer. The NO_{X} sensing electrode has a first electrochemical sensitivity to NO₂ that is greater than second and third electrochemical sensitivities to NH₃ and NO, respectively. The sensor also includes first and second electrical leads respectively connected to the NH₃ and NO_{X} sensing electrodes. The output signal developed across the first and second leads is directly indicative of an ammonia concentration in a gas exposed to the NH₃ and NO_{X} sensing electrodes.

Other aspects, features and advantages will be apparent from the detailed description that follows.

### BRIEF DESCRIPTION OF THE DRAWINGS

The present invention will now be described by way of example, with reference to the accompanying drawings:

FIG. 1 is an exploded view of a first, exemplary planar sensor element.

FIG. 2 is a graphical representation for the first embodiment of the voltage across an NH₃ cell, the voltage across a NO_{X} cell, and the voltage across an NH₃—NO_{X} cell, at selected partial pressures of NO_{X} and of NH₃ in a sample gas.

FIG. 3 is an exploded view of a second, simplified ammonia sensor element embodiment.

FIG. 4 is a cross-sectional view of the sensor element of FIG. 3.

FIG. 5 is a time-versus-emf diagram showing the relative NO and NH₃ sensitivity of a NO_{X} electrode of the sensor element of FIGS. 3 and 4.

FIG. 6 is a time-versus-concentration diagram showing the sensor element output, as converted to ammonia concentration, as compared to a reference.

### DETAILED DESCRIPTION OF THE PREFERRED EMBODIMENT

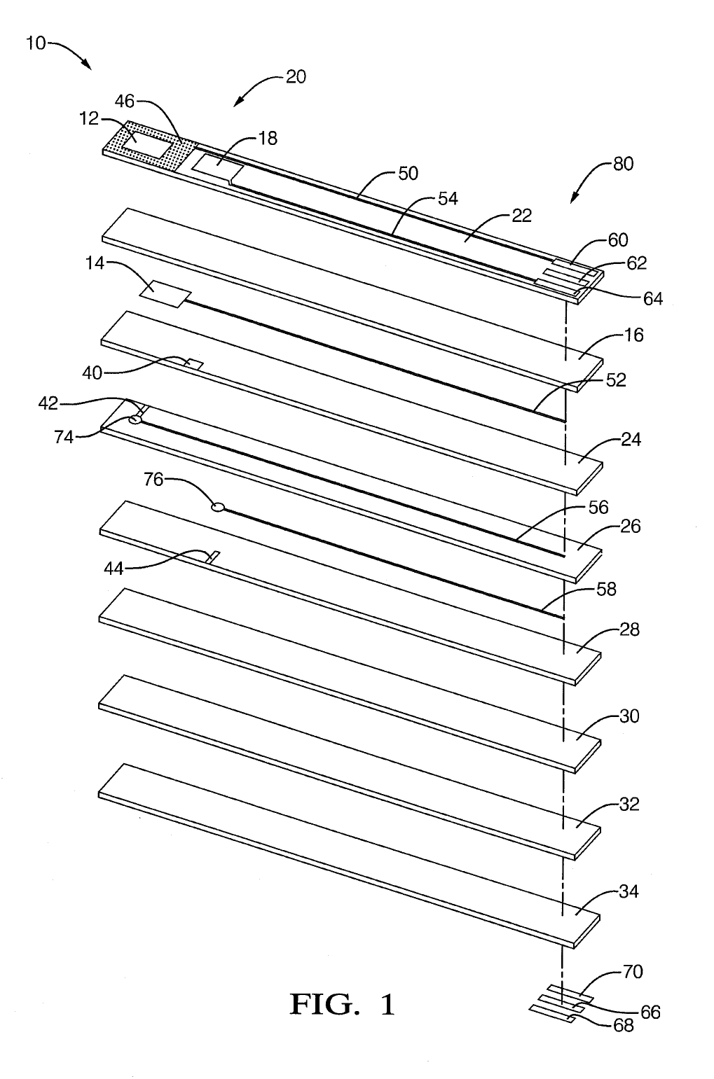

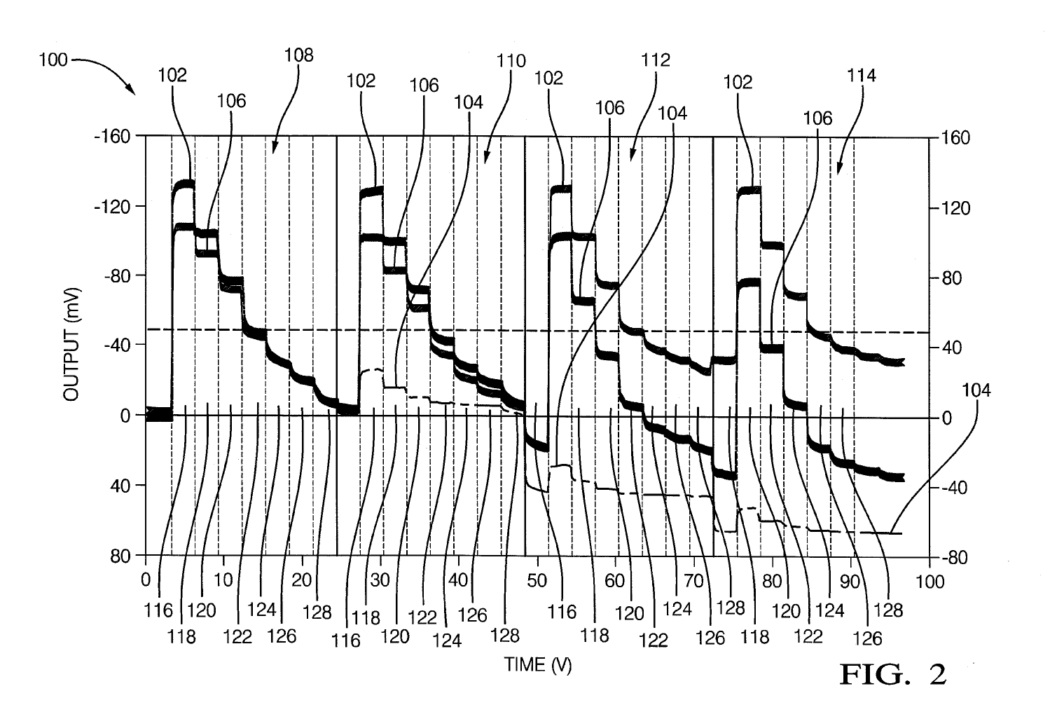

Referring now to the drawings wherein like reference numerals are used to identify identical components in the various views, FIGS. 1 and 2 depict the structure and operation of a multi-cell ammonia sensor element 10. Ammonia sensing is achieved, generally speaking, by using non-equilibrium electrochemical sensing principles. The sensor element 10 includes a first sensing cell with an ammonia sensing electrode. However, the ammonia sensing electrode incurs a cross interference sensing effect due to the presence of NO₂ in the measurement gas. To correct for this effect, the NO₂ concentration needs to be known. For this purpose, a second, NOₓ sensing cell is provided. The information obtained from the NOₓ sensing cell is then used to correct for the NO₂ cross interference effect.

The dual-cell structure of sensor element 20 features six (internal) electrical contact pads configured for connection to six corresponding electrical leads (wires). The electrical leads permit communication with an electronic controller or the like. The six leads includes one for the NH₃ (ammonia) sensing electrode, one for the NOₓ sensing electrode, one for a reference electrode, two for a heater and two for a temperature probe (i.e., one of temperature connections is shared with the reference electrode). The sensor element 10 provides (1) a first output signal (i.e., electromotive force—emf) between the NH₃ sensing electrode and the reference electrode; and (2) a second output signal (emf) between the NH₃ sensing electrode and the NO_{X} sensing electrode.

With the sensor element 10, the electronic controller must be configured with a set of selection rules (viz. in software) for selecting one of the two emf's choices described above. The dual-cell sensor element 10 of FIGS. 1 and 2 thus requires six electrical leads to the electronic controller as well as software-implemented selection rules.

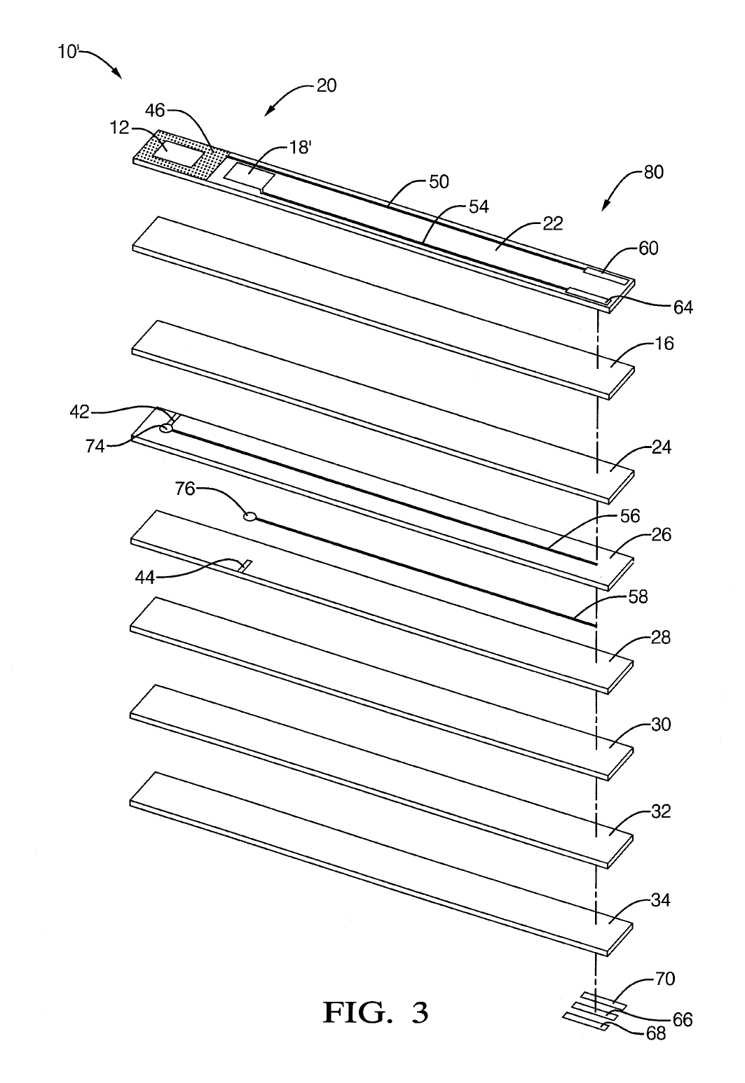

On the other hand, FIGS. 3-6 illustrate a simplified single-cell sensor element 10′. Its ammonia sensing cell has an ammonia sensing electrode and a reference (NOₓ) electrode that will eliminate the cross-interference effect that NO₂ has on the ammonia sensing electrode. The sensor element 10′ features a reduced number of electrical contact pads (i.e., five) configured for connection to five corresponding electrical leads (wires) to the electronic controller. Among other things, two, rather than three, of the contacts are used for ammonia detection. In addition, the controller need not be configured with any emf selection rules since the emf developed across the two sensing leads directly indicates the detected ammonia concentration. Each of these two designs will be addressed in turn.

Referring now to FIG. 1, in an exemplary embodiment, a sensor element 10 comprises a NH₃ sensing cell; comprising a NH₃ electrode 12, a reference electrode 14 and an electrolyte 16 (12/16/14), a NO_{X} sensing cell, comprising a NO_{X} electrode 18, the reference electrode 14 and the electrolyte 16 (18/16/14), and an NH₃—NO_{X} sensing cell, comprising the NH₃ and NO_{X} electrodes 12, 18 and the electrolyte 16 (12/16/18). The NH₃ sensing cell 12/16/14, the NO_{X} sensing cell 18/16/14, and the NO_{X}—NH₃ sensing cell 12/16/18 are disposed at a sensing end 20 of the sensor element 10. The sensor comprises insulating layers 22, 24, 28, 30, 32, 34, and active layers, which include layer 26 and the electrolyte layer 16. The active layers can conduct oxygen ions, where the insulating layers can insulate sensor components from electrical and ionic conduction and/or provide structural integrity. In an exemplary embodiment, the electrolyte layer 16 is disposed between insulating layers 22 and 24, and active layer 26 is disposed between insulating layers 24 and 28.

The sensor element 10 can further comprise, a temperature sensing cell (and/or air to fuel ratio sensor) comprising the active layer 26 and electrodes 74 and 76 (74/26/76), a heater (not shown), and/or an electromagnetic force shield (not shown). An inlet 40 can be defined by a first surface of the insulating layer 24, and by a surface of the electrolyte 16, proximate reference electrode 14. An inlet 42 can be defined by a first surface of the active layer 26 and by a second surface of the insulating layer 24. An inlet 44 can be defined by a surface of the layer 28 and a second surface of the active electrolyte layer 26. In addition, the sensor element 10 can comprise a current collector 46, electrical leads 50, 52, 54, 56, 58, contact pads 60, 62, 64, 66, 68, 70, ground plane (not shown), ground plane layers(s) (not shown), and the like.

For placement in a gas stream, sensor element 10 can be disposed within a protective casing (not shown) having holes, slits, and/or apertures, which can optionally act to generally limit the overall exhaust gas flow in physical communication with sensor element 10.

The NH₃ electrode 12 is disposed in physical and ionic communication with the electrolyte 16 and can be disposed in fluid communication with a sample gas (e.g., a gas being monitored or tested for its ammonia concentration). Under the operating conditions of the sensor element 10, the general properties of the NH₃ electrode material include NH₃ sensing capability (e.g., catalyzing NH₃ gas to produce an electromotive force (emf)), electrical conducting capability (conducting electrical current produced by the emf), and gas diffusion capability (providing sufficient open porosity so that gas can diffuse throughout the electrode and to the interface region of the NH₃ electrode 12 and the electrolyte 16). Possible NH₃ electrode materials include first oxide compounds of vanadium (V), tungsten (W), and molybdenum (Mo), as well as combinations comprising at least one of the foregoing, which can be doped with second oxide components, which can increase the electrical conductivity or enhance the NH₃ sensing sensitivity and/or NH₃ sensing selectivity to the first oxide components. Exemplary first components include the ternary vanadate compounds such as bismuth vanadium oxide (BiVO₄), copper vanadium oxide (Cu₂(VO₃)₂), ternary oxides of tungsten, and/or ternary molybdenum (MoO₃), as well as combinations comprising at least one of the foregoing. Exemplary second component metals include oxides such as alkali oxides, alkali earth oxides, transition metal oxides, rare earth oxides, and oxides such as SiO₂, ZnO, SnO, PbO, TiO₂, In₂O₃, Ga₂O₃, Al₂O₃, GeO, and Bi₂O₃, as well as combinations comprising at least one of the foregoing. The NH₃ electrode material can also include traditional oxide electrolyte materials such as zirconia, doped zirconia, ceria, doped ceria, or SiO₂, Al₂O₃ and the like, e.g., to form porosity and increase the contact area between the NH₃ electrode material and the electrolyte. Additives of low soft point glass frit materials can be added to the electrode materials as binders to bind the electrode materials to the surface of the electrolyte. Further examples of NH₃ sensing electrode materials can be found in U.S. application Ser. No. 10/734,018, now U.S. Pat. No. 7,074,319 entitled “AMMONIA GAS SENSORS” issued to Wang et al., commonly assigned herewith, and incorporated by reference.

The current collector 46 is disposed in physical contact and electrical communication with a periphery of the NH₃ electrode 12 and the electrical lead 50. The current collector 46 is disposed so as to have minimal, and more specifically, no physical contact with the electrolyte 16. Under the operating conditions of the sensor element 10, the general properties of the current collector 46 include (i) electrical conducting capability (ability to collect and conduct current), and (ii) low or no catalytic, electrochemical, and chemical reactivity (e.g., so as not to significantly react with the sample gas). Possible materials for the current collector can include non-reactive gold (Au), platinum (Pt), palladium (Pd), rhodium (Rh), as well as combinations comprising at least one of the foregoing (e.g., gold platinum alloys (Au—Pt), gold palladium alloys (Au—Pd), that have been processed to have the desired chemical reactivity). Other examples include unalloyed Group VIII refractory metals such as iridium (Tr), osmium (Os), ruthenium (Ru), and rhodium (Rh). Current collector 46 can include additives to reduce the material's reactivity with the sample gas. For example, stuffing Pt with alumina (Al₂O₃) and/or with silica (SiO₂) will decrease gas reactivity by eliminating the porosity of the material, decreasing the surface area available for gas reactions, and rendering the Pt non-reactive.

The reference electrode 14 is disposed in physical contact and ionic communication with the electrolyte 16 and can be disposed in fluid communication with the sample gas or reference gas; preferably with the sample gas. Under the operating conditions of sensor element 10, the general properties of the material forming the reference electrode 14 include: equilibrium oxygen catalyzing capability (e.g., catalyzing equilibrium O₂ gas to produce an emf), electrical conducting capability (conducting electrical current produced by the emf), and gas diffusion capability (providing sufficient open porosity so that gas can diffuse throughout the electrode and to the interface region of the electrode 14 and electrolyte 16). Possible electrode materials include platinum (Pt), palladium (Pd), osmium (Os), rhodium (Rh), iridium (Tr), gold (Au), and ruthenium (Ru), as well as combinations comprising at least one of the foregoing materials. The electrode can include metal oxides such as zirconia and/or alumina that can increase the electrode porosity and increase the contact area between the electrode and the electrolyte. In another embodiment, the reference electrode 14 can comprise two separate reference electrodes. In this embodiment, one reference electrode could be disposed in electrical and ionic communication with the NH₃ sensing cell and a different reference electrode could be disposed in electrical and ionic communication with the NO_{X} sensing cell.

The NO_{X} electrode 18 is disposed in physical contact and ionic communication with the electrolyte 16 and can be disposed in fluid communication with the sample gas. Under the operating conditions of sensor element 10, the general properties of the NOₓ electrode material(s) include, NOₓ sensing capability (e.g., catalyzing NOₓ gas to produce an emf), electrical conducting capability (conducting electrical current produced by the emf), and gas diffusion capability (providing sufficient open porosity so that gas can diffuse throughout the electrode and to the interface region of the electrode and electrolyte). These materials can include oxides of ytterbium, chromium, europium, erbium, zinc, neodymium, iron, magnesium, gadolinium, terbium, chromium, as well as combinations comprising at least one of the foregoing, such as YbCrO₃, LaCrO₃, ErCrO₃, EuCrO₃, SmCrO₃, HoCrO₃, GdCrO₃, NdCrO₃, TbCrO₃, ZnFe₂O₄, MgFe₂O₄, and ZnCr₂O₄, as well as combinations comprising at least one of the foregoing. Further, the NO_{X} electrode can comprise dopants that enhance the material(s)' NOₓ sensitivity and selectivity and electrical conductivity at the operating temperature. These dopants can include one or more of the following elements: Ba (barium), Ti (titanium), Ta (tantalum), K (potassium), Ca (calcium), Sr (strontium), V (vanadium), Ag (silver), Cd (cadmium), Pb (lead), W (tungsten), Sn (tin), Sm (samarium), Eu (europium), Er (Erbium), Mn (manganese), Ni (nickel), Zn (zinc), Na (sodium), Zr (zirconium), Nb (niobium), Co (cobalt), Mg (magnesium), Rh (rhodium), Nd (neodymium), Gd (gadolinium), and Ho (holmium), as well as combinations comprising at least one of the foregoing dopants.

Under the operating conditions of the sensor element 10, a general property of the electrolyte 16 is oxygen ion conducting capability. It can be dense for fluid separation (limiting fluid communication of the gases on each side of the electrolyte 16) or porous to allow fluid communication between the two sides of the electrolyte. The electrolyte 16 can comprise any size such as the entire length and width of the sensor element 10 or any portion thereof that provides sufficient ionic communication for the NH₃ cell (12/16/14), for the NOₓ cell (18/16/14), and for the NH₃—NOₓ cell (12/16/18). Possible electrolyte materials include zirconium oxide (zirconia) and/or cerium oxide (ceria), LaGaO₃, SrCeO₃, BaCeO₃, CaZrO₃, e.g., doped with calcium oxide, yttrium oxide (yttria), lanthanum oxide, magnesium oxide, alumina oxide, and indium oxide, as well as combinations comprising at least one of the foregoing electrolyte materials, such as yttria doped zirconia, and the like.

The temperature sensing cell (74/26/76) can detect temperature of the sensing end 20 of the sensing element. The gas inlet 42 and 44 are to provide oxygen from the exhaust to the active layer 26 (e.g., an electrolyte layer) and avoid electrolyte 26 from being reduced electrically during the temperature measurement (electrolyte impedance method). The temperature sensor can be any shape and can comprise any temperature sensor capable of monitoring the temperature of the sensing end 20 of the sensor element 10, such as, for example, an impedance-measuring device or a metal-like resistance-measuring device. The metal-like resistance temperature sensor can comprise, for example, a line pattern (connected parallel lines, serpentine, and/or the like). Some possible materials include, but are not limited to, electrically conductive materials such as metals including platinum (Pt), copper (Cu), silver (Ag), palladium (Pd), gold (Au), and tungsten (W), as well as combinations comprising at least one of the foregoing.

A heater (not shown) can be employed to maintain the sensor element 10 at a selected operating temperature. The heater can be positioned as part of the monolithic design of the sensor element 10, for example between insulating layer 32 and insulating layer 34, in thermal communication with the temperature sensing cell 42/26/44 and the sensing cells 12/16/14, 18/16/14, and 12/16/18. In other embodiments, the heater could be in thermal communication with the cells without necessarily being part of a monolithic laminate structure with them, e.g., simply by being in close physical proximity to a cell. More particularly, the heater can be capable of maintaining the sensing end 20 of the sensor element 10 at a sufficient temperature to facilitate the various electrochemical reactions therein. The heater can be a resistance heater and can comprise a line pattern (connected parallel lines, serpentine, and/or the like). The heater can comprise, for example, platinum, aluminum, palladium, and combinations comprising at least one of the foregoing. Contact pads, for example the fourth contact pad 66 and the fifth contact pad 68, can transfer current to the heater from an external power source.

Disposed between the insulating layer 32 and another insulating layer (not shown) can be an electromagnetic shield (not shown). The electromagnetic shield isolates electrical influences by dispersing electrical interferences and creating a barrier between a high power source (such as the heater) and a low power source (such as the temperature sensor and the gas sensing cells). The shield can comprise, for example, a line pattern (connected parallel lines, serpentine, cross hatch pattern and/or the like). Some possible materials for the shield can include those materials discussed above in relation to the heater.

The first, second, and third electrical leads 50, 52, 54, are disposed in electrical communication with the first, second, and third contact pads 60, 62, 64, respectively, at the terminal end 80 of the sensor element 10. The fourth electrical lead 56 is disposed in electrical communication with the second contact pad 62. The fifth electrical lead 58 is disposed in electrical communication with the fourth contact pad 66. The fifth and sixth contact pads 68 and 70 can be used to supply electrical current from an external power source to cell components (e.g., the heater). The second, fourth, and fifth leads 52, 56, 58, are in electrical communication with the contacts pads through vias formed in the layers 22, 24, 28, 30, 32, 34 of the sensor element 10. Further, the first electrical lead 50 is disposed in physical contact and in electrical communication with the current collector 46 at a sensing end 20 of the sensor element 10. The second electrical lead 52 is disposed in physical contact and electrical communication with the reference electrode 14 at the sensing end 20. The third electrical lead 54 is disposed in physical contact and electrical communication with the NO, electrode 18 at the sensing end 20. The fourth electrical lead 56 is disposed in physical contact and in electrical communication with the electrode 74 and the fifth electrical lead 58 is disposed in physical contact and electrical communication with the electrode 76 of at the sensing end 20 of the sensor element 10. The lead 54 can be put under and protected by the layer 22. The lead 50 can be protected by putting an additional insulation layer on top of it.

The electrical leads 50, 52, 54, 56, 58, and the contact pads 60, 62, 64, 66, 68, 70 can be disposed in electrical communication with a processor (not shown). The electrical leads 50, 52, 54, 56, and the contact pads 60, 62, 64, 66, 68, 70, can comprise any material with relatively good electrical conducting properties under the operating conditions of the sensor element 10. Examples of these materials include gold (Au), platinum (Pt), palladium (Pd), Group VIII refractory metals such as iridium (Tr), osmium (Os), ruthenium (Ru), and rhodium (Rh), and combinations comprising at least one of the foregoing materials (e.g., gold platinum alloys (Au—Pt), gold palladium alloys (Au—Pd), and an unalloyed Group III refractory metal). Another example is material comprising aluminum and silicon, which can form a hermetic adherent coating that prevents oxidation.

The insulating layers 22, 24, 28, 30, 32, 34, can comprise a dielectric material such as alumina (i.e., aluminum oxide (Al₂O₃), and the like). Each of the insulating layers can comprise a sufficient thickness to attain the desired insulating and/or structural properties. For example, each insulating layer can have a thickness of up to about 200 micrometers or so, depending upon the number of layers employed, or, more specifically, a thickness of about 50 micrometers to about 200 micrometers. Further, the sensor element 10 can comprise additional insulating layers to isolate electrical devices, segregate gases, and/or to provide additional structural support.

The active layer 26 can comprise material that, while under the operating conditions of sensor element 10, is capable of permitting the electrochemical transfer of oxygen ions. These include the same or similar materials to those described as comprising electrolyte 16. Each active layer (including each electrolyte layer) can comprise a thickness of up to about 200 micrometers or so, depending upon the number of layers employed, or, more specifically, a thickness of about 50 micrometers to about 200 micrometers.

In an alternative arrangement, electrodes 12 and 18 can be put side by side (instead of 12 on top and 18 on bottom as shown in FIG. 1) or can be put 18 on top and 12 on the bottom.

The sensor element 10 can be formed using various ceramic-processing techniques. For example, milling processes (e.g., wet and dry milling processes including ball milling, attrition milling, vibration milling, jet milling, and the like) can be used to size ceramic powders into desired particle sizes and desired particle size distributions to obtain physical, chemical, and electrochemical properties. The ceramic powders can be mixed with plastic binders to form various shapes. For example, the structural components (e.g. insulating layers 22, 24, 28, 30, 32, and 34, the electrolyte 16 and the active layer 26) can be formed into “green” tapes by tape-casting, role-compacting, or similar processes. The non-structural components (e.g., the NH₃ electrode 12, the NOₓ electrode 18, and the reference electrode 14, the current collector 46, the electrical leads, and the contact pads) can be formed into tape or can be deposited onto the structural components by various ceramic-processing techniques (e.g., sputtering, painting, chemical vapor deposition, screen-printing, stenciling, and so forth).

In one embodiment, the ammonia electrode material is prepared and disposed onto the electrolyte (or the layer adjacent to the electrolyte). In this method, the primary material, e.g., in the form of an oxide, is combined with the dopant secondary material and optional other dopants, if any, simultaneously or sequentially. By either method, the materials are mixed to enable the desired incorporation of the dopant secondary material and any optional dopants into the primary material to produce the desired ammonia-selective material. For example, V₂O₅ is mixed with Bi₂O₃ and MgO by milling for about 2 to about 24 hours. The mixture is fired to about 800° C. to about 900° C. for a sufficient period of time to allow the metals to transfer into the vanadium oxide structure and produce the new formulation (e.g., BiMg_{0.05}V_{0.95}O₄₋ₓ (wherein x is the difference in the value between the stoichiometric amount of oxygen and the actual amount)), which is the reaction product of the primary material, secondary material and optional chemical stabilizing dopant, and/or diffusion impeding dopant. The period of time is dependent upon the specific temperature and the particular materials but can be about 1 hour or so. Once the ammonia-selective material has been prepared, it can be made into ink and disposed onto the desired sensor layer. The BiVO₄ is the primary NH₃ sensing material, and the dopant Mg is used to enhance its electrical conductivity.

The NOₓ electrode material can be prepared and disposed onto the electrolyte by similar methods. For example, Tb₄O₇ can be mixed with MgO and Cr₂O₃ with soft glass additives by milling for about 2 to about 24 hours. The mixture is fired to up to about 1,400° C. or so for a sufficient period of time to allow the metals to transfer into the oxide structure and produce the new formulation (e.g., TbCr_{0.8}Mg_{0.2}O_{2.9-x} (wherein x is the difference in the value between the stoichiometric amount of oxygen and the actual amount)), which is the reaction product of the primary material, secondary material and optional chemical stabilizing dopant, and/or diffusion impeding dopant.

The inlets 40, 42, 44 can be formed either by disposing fugitive material (material that will dissipate during the sintering process, e.g., graphite, carbon black, starch, nylon, polystyrene, latex, other insoluble organics, as well as compositions comprising one or more of the foregoing fugitive materials) or by disposing material that will leave sufficient open porosity in the fired ceramic body to allow gas diffusion therethrough. Once the “green” sensor is formed, the sensor can be sintered at a selected firing cycle to allow controlled burn-off of the binders and other organic material and to form the ceramic material with desired microstructural properties.

During use, the sensor element is disposed in a gas stream, e.g., an exhaust stream in fluid communication with engine exhaust. In addition to NH₃, O₂, and NOₓ, the sensor's operating environment can include, hydrocarbons, hydrogen, carbon monoxide, carbon dioxide, nitrogen, water, sulfur, sulfur-containing compounds, combustion radicals, such as hydrogen and hydroxyl ions, particulate matter, and the like. The temperature of the exhaust stream is dependent upon the type of engine and can be about 200° C. to about 550° C., or even about 700° C. to about 1,000° C.

The NH₃ sensing cell 12/16/14, the NOₓ sensing cell 18/16/14, and the NOₓ—NH₃ sensing cell 12/16/18 can generate emf as described by the Nernst Equation. In the exemplary embodiment, the sample gas is introduced to the NH₃ electrode 12, the reference electrode 14 and the NOₓ electrode 18 and is diffused throughout the porous electrode materials. In the electrodes 12 and 18, electro-catalytic materials induce electrochemical-catalytic reactions in the sample gas. These reactions include electrochemical-catalyzing NH₃ and oxide ions to form N₂ and H₂O, electrochemical-catalyzing NO₂ to form NO, N₂ and oxide ions, and electro-catalyzing NO and oxide ions to form NO₂. Similarly, in the reference electrode 14, electrochemical-catalytic material induces electrochemical reactions in the reference gas, primarily converting equilibrium oxygen gas (O₂) to oxide ions (O⁻²) or vice versa. The reactions at the electrodes 12, 14, 18 change the electrical potential at the interface between each of the electrodes 12, 14, 18 and the electrolyte 16, thereby producing an electromotive force. Therefore, the electrical potential difference between any two of the three electrodes 12, 14, 18 can be measured to determine an electromotive force.

The primary reactants at the electrodes of the NH₃ sensing cell 12/16/14 are NH₃, H₂O, and O₂. The partial pressure of reactive components at the electrodes of the NH₃ sensing cell 12/16/14 can be determined from the cell's electromotive force by using the non-equilibrium Nernst Equation (1):

$$emf \approx \frac{kT}{ae} Ln ( {P}_{{NH}_{3}} ) - \frac{kT}{be} Ln ( {P}_{{o}_{2}} ) - \frac{kT}{ce} Ln ( {P}_{{H}_{2} O} ) ) + constant \qquad ( 1 )$$

where: k=the Boltzmann constant

T=the absolute temperature of the gas

e=the electron charge unit

a, b, c, f, are constant

Ln=natural log

P_{NH}_{₃}=the partial pressure of ammonia in the gas,

P_{O}_{₂}=the partial pressure of oxygen in the gas,

P_{NO}_{₂}=the partial pressure of nitrogen dioxide in the gas

P_{H}_{₂}_{O}=the partial pressure of water vapor in the gas

P_{NO}=the partial pressure of nitrogen monoxide in the gas.

A temperature sensor can be used to measure a temperature indicative of the absolute gas temperature (T). The oxygen and water vapor content, e.g., partial pressures, in the unknown gas can be determined from the air-fuel ratio. Therefore, the processor can apply Equation (1) (or a suitable approximation thereof) to determine the amount of NH₃ in the presence of O₂ and H₂O, or the processor can access a lookup table from which the NH₃ partial pressure can be selected in accordance with the electromotive force output from the NH₃ sensing cell 12/16/14.

The air to fuel ratio can be obtained by ECM (engine control modulus, e.g., see GB2347219A) or by building an air to fuel ratio sensor in the sensor 10. Alternatively, a complete mapping of H₂O and O₂ concentrations under all engine running conditions (measured by instrument such as mass spectrometer) can be obtained empirically and stored in ECM in a virtual look-up table with which the sensor circuitry communicates. Once the oxygen and water vapor content information is known, the processor can use the information to more accurately determine the partial pressures of the sample gas components. Typically, the water and oxygen correction according to Equation (1) is a small number within the water and oxygen ranges of diesel engine exhaust. This is especially true when the water is in the range of 1.5 weight percent (wt %) to 10 wt % in the engine exhaust. This is because the water and oxygen have opposite sense of increasing or decreasing at any given air to fuel ratio and both effects cancel each other in Equation (1). Where there is no great demand for sensing accuracy (such as ±0.1 part per million by volume (ppm)), the water and oxygen correction in Equation 1 is unnecessary.

The emf output of the NH₃ cell can be interfered by NO₂ in the sample gas (see FIG. 2). For this reason we use a NOₓ cell to correct this interference effect.

The primary reactants at electrodes of the NOₓ sensing cell 18/16/14 are NO, H₂O, NO₂, and O₂. The partial pressure of reactive components at the electrodes of the NOₓ sensing cell 18/16/14 can be determined from the cell's electromotive force by using the non-equilibrium Nernst Equation, Equation (2):

$$emf \approx \frac{kT}{2 e} Ln ( {P}_{NO} ) - \frac{kT}{4 e} Ln ( {P}_{{O}_{2}} ) - \frac{kT}{2 e} Ln ( {P}_{{H}_{2} O} ) - \frac{kT}{2 e} Ln ( {P}_{{NO}_{2}} ) + constant \qquad ( 2 )$$

From Equation (2), at relatively low NO₂ partial pressures, the cell will produce a positive emf. At relatively high NO₂ partial pressures, the cell will produce a negative emf (with electrode 14 set at positive polarity).

The primary reactants at the electrodes of the NH₃—NOₓ sensing cell 12/16/14 are NH₃, NO, H₂O, NO₂, and O₂. The partial pressure of reactive components at these electrodes can be determined from the cell's electromotive force by using the non-equilibrium Nernst Equation that takes into account the effect of both Equation 2 and Equation 1.

At relatively high concentrations of NO₂, the NO₂ reacts at both the NH₃ electrode 12 and the NOₓ electrode 18. Therefore, the electrical potential at the NH₃ electrode 12 due to NO₂ reactions is approximately equal to the electrical potential at the NOₓ electrode 18 due to NO₂ reactions, resulting in zero overall change in electromotive force due to reactions involving NO₂. Therefore, in the NH₃—NOₓ sensing cell 18/16/12, when the NO₂ concentrations are relatively high, the amount of NH₃ becomes the only unknown in Equation (1). The processor can use emf output of cell 12/16/18 directly (or a suitable approximation thereof) to determine the amount of NH₃ in the presence of O₂ and H₂O, or the processor can access a lookup table from which the NH₃ partial pressure can be selected in accordance with the electromotive force output from the NH₃—NOₓ sensing cell 12/16/18 and from the air-fuel ratio information provided by the engine ECM. In most diesel exhaust conditions, the O₂ and H₂O effect will cancel each other such that there is no need to do air to fuel ratio correction of the emf output data.

Since at lower NO₂ partial pressures, the NH₃ sensing cell (12/22/14) more accurately detects NH₃, but at higher NO₂ partial pressures, the NH₃—NOₓ sensing cell (12/22/18) more accurately detects NH₃, the processor selects the appropriate cell according to the selection rule below:

1. Whenever the electromotive force between the NOₓ electrode 18 and the reference electrode 14 (measured at positive polarity) is greater than a selected emf (e.g., 0 millivolts (mV), +10 mV, or −10 mV), the NH₃ electromotive force is equal to the electromotive force measured between the NH₃ electrode 12 and the reference electrode 14. The selected emf is typically determined from the emf of cell 18/16/14 in the presence of zero NH₃ and NOₓ.

2. Whenever the electromotive force between the NOₓ electrode 18 and the reference electrode 14 is not greater than the selected emf (e.g., 0 millivolts (mV), +10 mV, or −10 mV), the NH₃ electromotive force is equal to the electromotive force between the NH₃ electrode 12 and the NOₓ electrode 18.

Referring to FIG. 2, a graphical representation 100 is shown. The tested sensor had a BiVO₄ (5% MgO) NH₃ electrode, a TbMg_{0.2}Cr_{0.8}O_{3 NO}ₓ electrode, and a Pt reference electrode. The sensor was operated at 560° C. The graphical representation includes a line representing the voltage (line 102) across the NH₃ sensing cell, a line representing the voltage (line 104) across the NOₓ sensing cell, and a line 106 representing the voltage across the NH₃—NOₓ cell. The graphical representation 100 further includes four sections representing NO₂ and NO concentrations: a first section 108 where NO and NO₂ concentrations are 0 ppm (parts per million), a second section 110 where NO concentration is 400 ppm and NO₂ concentration is 0 ppm, a third section 112 where NO concentration is 200 ppm and NO₂ concentration is 200 ppm, and a fourth 114 section where NO concentration is 0 ppm and NO₂ concentration is 400 ppm. Each of the sections 108, 110, 112, 114, include seven subsections representing NH₃ concentrations: a first subsection 116 where the NH₃ concentration is 100 ppm, a second subsection 118 where the NH₃ concentration is 50 ppm, a third subsection 120 where the NH₃ concentration is 25 ppm, a fourth subsection 122 where the NH₃ concentration is 10 ppm, a fifth subsection 124 where the NH₃ concentration is 5 ppm, a sixth subjection 126 where the NH₃ concentration is 2.5 ppm, and a seventh subjection 128 where the NH₃ concentration is 0 ppm. The remaining gas is composed of 10% O₂, 1.5% of H₂O and balanced by N₂. As shown in FIG. 2, although the line 102 is identical in section 108 and 110, it has a lower value in section 112 and 114 where NO₂ is present.

In an exemplary embodiment, the emf of NOₓ cell at 0 NOₓ is 0 mV (see line 104 at section 128), therefore the selected emf is a voltage of zero. When NO₂ concentration is 0 ppm as in section 108 and section 110, the voltage (line 104) measured by the sensor across the NOₓ sensing cell would be greater than 0. Therefore, the sensor would use the voltage (line 102) across the NH₃ sensing cell to determine the NH₃ concentration in the sample gas. When NO₂ concentration is 200 as in section 112 or 400 ppm as in section 114, the voltage (line 104) across the NOₓ sensing cell will not be greater than 0. Therefore, the sensor would use the voltage 106 across the third sensing cell (the NH₃—NOₓ sensing cell) to determine the NH₃ concentration in the sample gas. As can be seen, the line 102 in sections 108 and 110 are almost identical to the line 106 in section 112 and 114, meaning that the NH₃ concentration can be determined without the interference of NO₂.

The sensing element 10 and method disclosed herein enable a more accurate NH₃ determination than was possible when the effects of NOₓ were not factored into the reading. This sensing element is capable of detecting ammonia at a concentration of 1 ppm without the interference of NOₓ. The devices have wide temperature ranges of operation (from 400° C. to 700° C.) and are independent of the flow rate of the exhaust. The self-compensation of the water and oxygen interference works for exhaust gas that has a water concentration equal or larger than 1.5%. Below this number, water and oxygen effect correction can be implemented by using Eq. 1, by using the look up table and the air to fuel ratio information provided by the ECM, or by an air fuel ratio sensor that can be a separate sensor or combined with this sensor.

FIG. 3 is an exploded view of a simplified ammonia sensor, designated 10′, that features a reduced number of lead wires (i.e., five) required for communication with an electronic controller (not shown). In addition, the electronic controller need not be configured to execute any emf selection rules since the emf developed across the sensing leads is directly indicative of the ammonia concentration in the measurement gas.

In the illustrative embodiment, the sensor element 10′, subject to the differences set forth below, is the same as the sensor element 10 described above in connection with FIGS. 1-2, and it should be understood that the previous description as to how to make and use the sensor element will be equally applicable, except as otherwise described below.

One difference, however, is that the sensor element 10′ eliminates the reference electrode 14 of the sensor element 10, as well as the related gas inlet and chamber 40. The sensor element 10′ still uses two sensing electrodes (to form an ammonia sensing cell) that will be exposed to the measurement gas (i.e., the ambient exhaust gas in an engine exhaust gas application), which is expected to contain ammonia, NO and NO₂, among other constituent components.

The first sensing electrode 12 is for sensing ammonia (NH₃) and is made of ammonia sensing materials (i.e., having an electrochemical sensitivity to ammonia). The NH₃ sensing electrode 12 is disposed on and in ionic communication with the electrolyte 16, as described above. In the illustrative embodiment, the NH₃ sensing electrode 12 that was used in the sensor element 10 above may also be used in sensor element 10′. Accordingly, the NH₃ sensing electrode 12 may comprise ammonia sensing materials made of vanadium (V), tungsten (W), and molybdenum (Mo) containing oxide materials, with other dopants to enhance ammonia sensing capability, response time and contact resistance, all as described above. In one embodiment, the NH₃ sensing electrode 12 of sensor element 10′ may comprise BiVO₄ doped with five (5) mole % MgO (i.e., BiV_{0.95}Mg_{0.05}O₄).

The second sensing electrode 18′ used in the sensor element 10′ is configured for sensing NO₂ but is less sensitive or not sensitive at all to NO and NH₃. In this way, the cross-interference effect that NO₂ has on the ammonia sensing electrode 12 can be corrected by a differential arrangement with the sensing electrode 18′. Accordingly, the sensor element 10′ includes a new material formulation for the NOₓ sensing electrode 18′ to replace the electrode 18 of sensor element 10 (FIG. 1). The new NOₓ sensing electrode 18′, as shown, is generally laterally offset from the NH₃ sensing electrode 12 and is disposed on and in ionic communication with the electrolyte 16. To achieve the above functionality, the sensing electrode 18′ has a first electrochemical sensitivity to NO₂ that is greater than second and third electrochemical sensitivities to both NO and NH₃, respectively. The NOₓ sensing electrode 18′ may comprise (i) a first material selected from the group comprising Cr-containing oxide material, Fe-containing oxide material and Ni-containing oxide material and combinations of at least any one thereof, and (ii) a second material, such as a dopant, configured to increase its first electrochemical sensitivity to NO₂ while decrease its second and third electrochemical sensitivities to NH₃ and NO, respectively. In addition, such a dopant can be included to enhance the electrode's response time and contact resistance. In one embodiment, the NOₓ sensing electrode 18 may comprise BaFe₁₂O₁₉ material doped with five (5) mole % of MgO. In another embodiment, the NOₓ sensing electrode 18′ may comprise BaFe_{11.8}Mg_{0.15}B_{0.05}O₁₉ material. Other examples of the NOₓ sensing electrode material may include BaFe_{11.95}Co_{0.05}O₁₉, Ba_{1.05}Fe_{11.99}Rh_{0.01}O₁₉, Ba_{1.05}Fe_{11.95}Mg_{0.05}O₁₉, BaFe_{11.95}Ca_{0.05}O₁₉, Ba_{0.95}Mg_{0.05}Fe₁₂O₁₉, Ba_{0.99}Pb_{0.01}Fe_{11.95}Mg_{0.05}O₁₉, BaFe_{11.95}Ni_{0.05}O₁₉, BaFe_{11.8}Mg_{0.19}Pb_{0.01}O₁₉, BaFe_{11.75}Mg_{0.25}O₁₉, BaFe_{11.80}Mg_{0.15}Pb_{0.05}O₁₉, BaFe_{11.95}B_{0.05}O₁₉, BaFe₁₁CuO₁₉, Ba_{11.99}Pt_{0.01}O₁₉. In general, the formula is BaFe₁₂O₁₉, and this formula can accommodate large additives stoichiometrically or non-stochiometrically as shown in the above examples.

With continued reference to FIG. 3, the sensing electrodes 12 and 18′ may be electrically connected, as shown, to contact pads 60 and 64, respectively. In addition, an electrically-operated heater (not shown) may also be included to maintain the sensor element 10′ at a substantially constant temperature (preferred), and whose two terminals may be coupled to two contact pads 68 and 70. A two-terminal temperature sensor may also be connected to contact pad 66 and contact pad 60. Thus, the single-cell sensor element 10′ includes just five electrical leads (wires) for connection to the five contact pads 60, 64, 66, 68 and 70: two leads for the heater and three leads for the temperature sensor and the ammonia sensor cell (i.e., they share a common lead). In one embodiment, contact pad 64 may be shared between the temperature sensor and the ammonia sensor cell (although the shared lead may alternatively be contact pad 60).

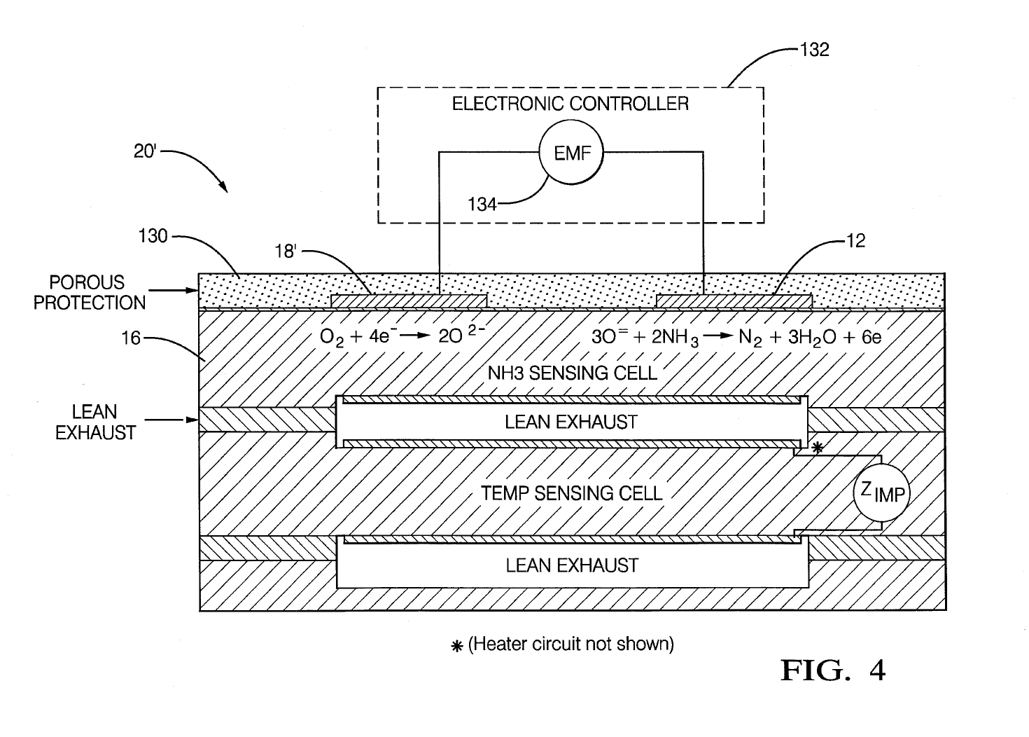

FIG. 4 is a cross-sectional view of the single-cell sensor element 10′. FIG. 4 further shows the sensor element 10′ including a porous (i.e. measurement gas permeable) protection layer 130, at least in the region of the sensing electrodes 12, 18′. The single-cell ammonia sensing cell is defined by the NH₃ and NOₓ sensing electrodes 12 and 18′ and the electrolyte 16. An electronic controller 132 or the like may include a mechanism, such as indicated at reference numeral 134, for measuring the emf developed across the ammonia sensing cell (12, 18′). As described above, since the improved structure of the sensor element 10′ addresses the NO₂ cross interference problem, the electronic controller 132 need not be configured with any emf selection rules, as was the case for the sensor element 10.

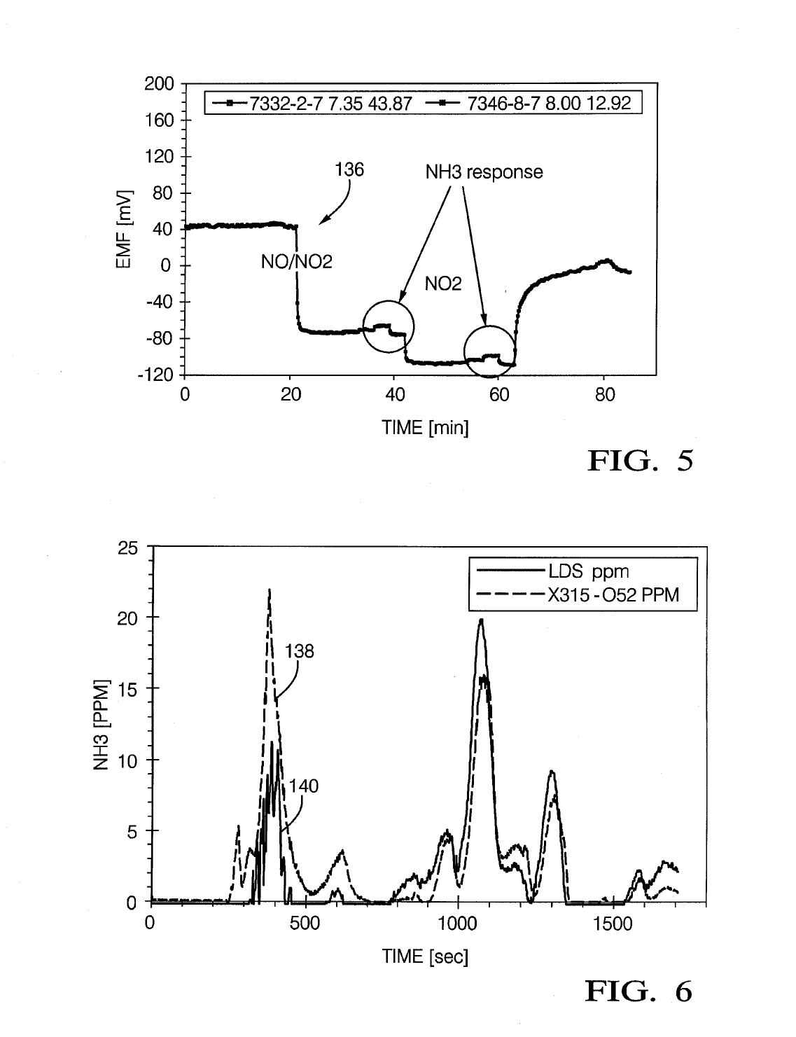

FIG. 5 shows the performance of one embodiment (comprising BaFe_{11.8}Mg_{0.15}B_{0.05}O₁₉ material) of the NOₓ sensing electrode 18′as illustrated in trace 136.

In FIG. 5, the emf response of the NOₓ electrode (with a Pt electrode as a reference electrode) is presented under four (from left to right) different gas conditions; 200 PPM NO (with NH₃ varied from 0-100 ppm), 100/100 ppm of NO/NO₂ (with NH₃ varied from 0-100 ppm), 200 PPM of NO₂ (with NH₃ varied from 0-100 ppm) and zero PPM of NOₓ (with NH₃ varied from 0-100 ppm). FIG. 5 shows that within the four NOₓ conditions, the emf has very little (less than 20 mV) or no emf response when NH₃ concentrations are varied (0, 5, 10, 20, 50, 100 PPM NH₃). The emf change at 200 ppm of NO is 40 m mV and at 200 PPM of NO₂ is 110 mV (absolute value). As clearly shown in this FIG. 5, this electrode does have a high emf response to NO₂ and a lesser response to NO and almost zero response to NH₃.

The emf developed across the NH₃ and NOₓ sensing electrodes 12 and 18′ is directly indicative of an ammonia gas concentration in the measurement gas exposed to the sensing electrodes. Accordingly, the observed emf may be converted to an ammonia gas concentration (ppm) using an equation in the form of equation (3):

Ammonia(ppm)=A+B*EXP(emf*C) (3)

where emf is the emf measured across the NH₃ and NOₓ sensing electrodes 12 and 18′, and where A, B and C are constants.

FIG. 6 shows the performance of a constructed embodiment of the single-cell ammonia sensor element 10′. The sensor element 10′ was exposed to diesel engine exhaust and compared with an engine bench ammonia sensing instrument. The trace 138 represents the output of the sensor element 10′ (i.e., as converted to ammonia PPM) while the trace 140 represents the output from a commercially available Siemens LDS ammonia sensor device (also expressed in PPM). Note, in FIG. 6, that the form of equation (3) was used, and where A=—3, B=1.5 and C=0.0275.

While the invention has been described in connection with a diesel exhaust application, it should be understood that the invention is not so limited. For example, embodiments consistent with the invention may be used in applications including but not limited to diesel exhaust after-treatment, agriculture, medical, chemical and environmental protection.

It should be noted that the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items. As used herein, “combination” is inclusive of blends, mixtures, alloys, reaction products, and the like, as appropriate. The modifier “about” used in connection with a quantity is inclusive of the stated value and has the meaning dictated by the context (e.g., includes the degree of error associated with measurement of the particular quantity). Furthermore, all ranges disclosed herein are inclusive and combinable (e.g., ranges of “up to about 25 weight percent (wt. %), with about 5 wt. % to about 20 wt.% desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A sensor, comprising:
an electrolyte layer;
an NH₃ sensing electrode disposed on and in ionic communication with said electrolyte layer;
a NOₓ sensing electrode offset from said NH₃ sensing electrode and disposed on and in ionic communication with said electrolyte layer, said NOₓ sensing electrode having a first electrochemical sensitivity to NO₂ that is greater than second and third electrochemical sensitivities to NH₃ and NO, respectively; and
first and second electrical leads respectively connected to said NH₃ and NOₓ sensing electrodes wherein an output signal developed across said first and second leads is indicative of an ammonia concentration in a gas exposed to said NH₃ and NOₓ sensing electrodes.

2. The sensor of claim 1 wherein said electrolyte layer is configured to conduct oxygen ions.

3. The sensor of claim 1 wherein said NH₃ sensing electrode comprises BiVO₄ material.

4. The sensor of claim 3 wherein said NH₃ sensing electrode comprises BiV_{0.95}Mg_{0.05}O₄ material.

5. The sensor of claim 1 wherein said NO, sensing electrode comprises (i) a first material selected from the group comprising Cr-containing oxide material, Fe-containing oxide material and Ni-containing oxide material and combinations comprising at least one of the foregoing, and (ii) a second, dopant material configured to increase said first electrochemical sensitivity to NO₂ and decrease said second and third electrochemical sensitivities to NH₃ and NO, respectively.

6. The sensor of claim 5 wherein said first material comprises BaFe₁₂O₁₉ material.

7. The sensor of claim 5 wherein said second, dopant material comprises MgO material.

8. The sensor of claim 5 wherein said first material comprises BaFe₁₂O₁₉ material and said second, dopant material comprises MgO material.

9. The sensor of claim 8 wherein said NOₓ sensing electrode comprises BaFe₁₂O₁₉ material doped with 5 mole % MgO.

10. The sensor of claim 1 wherein said NOₓ sensing electrode comprises BaFe_{11.8}Mg_{0.15}B_{0.05}O₁₉ material.

11. The sensor of claim 10 wherein said NH₃ sensing electrode comprises BiV_{0.95}Mg_{0.05}O₄ material.

12. The sensor of claim 1 further comprising a current collector comprising electrically-conductive material coupled to at least a periphery of said NH₃ sensing electrode, said current collector being isolated from said electrolyte.

13. The sensor of claim 1 further comprising an electrically-operated heater circuit connected to third and fourth electrical leads.

14. The sensor of claim 13 further comprising a temperature sensing circuit electrically connected to a fifth electrical lead and a selected one of said first and second electrical leads.
